(19) United States
(12) Patent Application Publication
(10) Pub. No.: US 2026/0204479 A1
(43) Pub. Date: Jul. 16, 2026

(54) MULTILAYER CERAMIC ELECTRONIC DEVICE

(71) Applicant: TAIYO YUDEN CO., LTD., Chuo-ku, Tokyo (JP)

(72) Inventor: Yu SUGAWARA, Takasaki-shi (JP)

(21) Appl. No.: 19/161,156

(22) PCT Filed: Nov. 10, 2023
(86) PCT No.: PCT/JP2023/040582

§ 371 Date: Aug. 29, 2025

(30) Foreign Application Priority Data
Mar. 17, 2023 (JP) 2023-043169

(51) Int. Cl. H01G 4/12; H01G 4/005; H01G 4/30

(52) U.S. Cl. CPC H01G 4/1227; H01G 4/005; H01G 4/30

(57) ABSTRACT

A multilayer ceramic electronic device includes an element body 10 including a multilayer portion in which a plurality of dielectric layers 11 and a plurality of internal electrode layers 12 are stacked, wherein at least one of the plurality of dielectric layers 11 includes a pyrochlore phase 50.

### TECHNICAL FIELD

The present invention relates to a multilayer ceramic electronic device.

### BACKGROUND ART

Multilayer ceramic electronic devices such as multilayer ceramic capacitors (MLCC: Multi-Layer ceramic capacitor) are used in high-frequency communication systems, such as mobile phones (see, for example, Patent Documents 1 to 3).

### PRIOR ART DOCUMENT

### Patent Document

Patent Document 1: Japanese Patent Application Publication No. 2018-524248
Patent Document 2: Internal Publication No. 2021/229919
Patent Document 3: Japanese Patent Application Publication No. 2016-113355

### DISCLOSURE OF THE INVENTION

### Problems to be Solved by the Invention

Multilayer ceramic electronic devices are becoming smaller and larger in capacity, and are being used in increasingly harsh environments such as automobiles and industrial equipment. In order to exhibit excellent dielectric properties even in harsh environments, it is desirable for them to have excellent bias characteristics and excellent temperature characteristics.

The present invention has been made in consideration of the above problems, and aims to provide a multilayer ceramic electronic device that can achieve excellent bias characteristics and excellent temperature characteristics.

### Means for Solving the Problem

A multilayer ceramic electronic device of the present invention includes an element body including a multilayer portion in which a plurality of dielectric layers and a plurality of internal electrode layers are stacked, wherein at least one of the plurality of dielectric layers includes a pyrochlore phase.

In the above-mentioned multilayer ceramic electronic device, the pyrochlore phase may be in contact with an adjacent one of the plurality of internal electrode layers.

In the above-mentioned multilayer ceramic electronic device, the adjacent one of the plurality of internal electrode layers may include a discontinuous portion, and the pyrochlore phase may cover the discontinuous portion and may be in contact with the adjacent one of the plurality of internal electrode layers.

In the above-mentioned multilayer ceramic electronic device, in the at least one of the plurality of dielectric layers including the pyrochlore phase, a cross section area of the pyrochlore phase in a cross section including a stacking direction may be 5% or more and 20% or less.

In the above-mentioned multilayer ceramic electronic device, in the at least one of the plurality of dielectric layers including the pyrochlore phase, a cross section area of the pyrochlore phase in a cross section including a stacking direction may be 10% or more and 20% or less.

In the above-mentioned multilayer ceramic electronic device, a height of the pyrochlore phase in a stacking direction may be 10% or more and 50% or less of an average thickness of the plurality of dielectric layers.

In the above-mentioned multilayer ceramic electronic device, a length of the pyrochlore phase in a direction in which the plurality of internal electrode layers extend may be 0.5 μm or more and 9.0 μm or less.

In the above-mentioned multilayer ceramic electronic device, a main component of the plurality of dielectric layers may be barium titanate, the pyrochlore phase may include a rare earth element, and the pyrochlore phase may be represented by a chemical formula R₂Ti₂O₇, where R is the rare earth element.

In the above-mentioned multilayer ceramic electronic device, the rare earth element may be at least one of europium, samarium, gadolinium, terbium, dysprosium, holmium, erbium, or yttrium.

In the above-mentioned multilayer ceramic electronic device, the rare earth element may be holmium.

In the above-mentioned multilayer ceramic electronic device, the plurality of dielectric layers may include a first sub-component including at least one of silicon or lithium, a second sub-component including boron, a third sub-component including calcium, a fourth sub-component including at least one of manganese or magnesium, and a fifth sub-component including at least one of niobium, tungsten, or molybdenum, and a total amount of the first sub-component, the second sub-component, the third sub-component, the fourth sub-component, the fifth sub-component, and the rare earth element in the plurality of dielectric layers may be 20 mol or more and 30 mol or less per 100 mol of titanium.

In the above-mentioned multilayer ceramic electronic device, a main component of the plurality of dielectric layers may be barium titanate in which molybdenum and manganese are solid-dissolved.

In the above-mentioned multilayer ceramic electronic device, the multilayer ceramic electronic device may satisfy X8S characteristics or X8R characteristics in EIA standard.

### Effect of Invention

According to the present invention, it is possible to provide a multilayer ceramic electronic device that can realize excellent bias characteristics and excellent temperature characteristics.

### BRIEF DESCRIPTION OF THE DRAWINGS

FIG. 1 Presented is a partial cross-sectional perspective view of a multilayer ceramic capacitor.

FIG. 2 Presented is a cross-sectional view taken along line A-A in FIG. 1.

FIG. 3 Presented is a cross-sectional view taken along line B-B in FIG. 1.

FIG. 4 (a) and (b) are enlarged views of the XZ cross section.

FIG. 5 Presented is a cross-sectional view showing a schematic representation of dielectric particles in a dielectric layer.

FIG. 6 Presented is a diagram illustrating the flow of a manufacturing method for a multilayer ceramic capacitor.

FIG. 7 (a) and (b) are diagrams illustrating the internal electrode formation process.

FIG. 8 Presented is a diagram illustrating the compression bonding process.

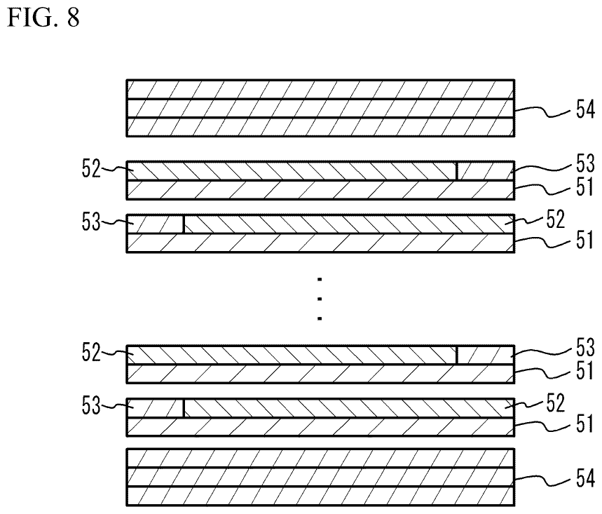

FIG. 9 Presented is a diagram illustrating a side margin portion.

### BEST MODES FOR CARRYING OUT THE INVENTION

Hereinafter, an exemplary embodiment will be described with reference to the accompanying drawings.

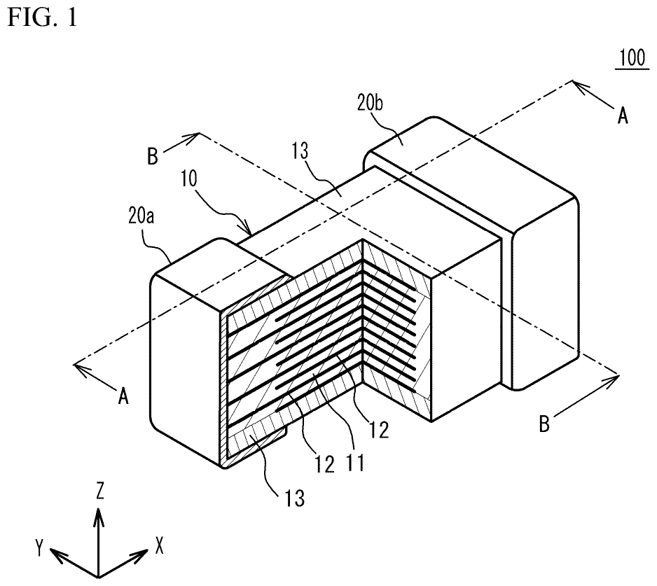

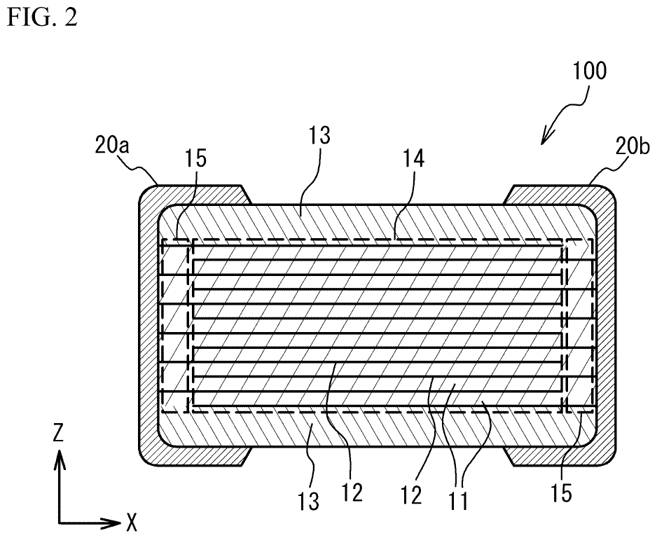

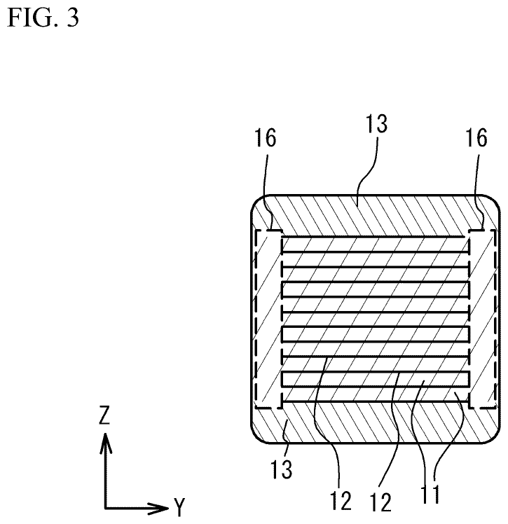

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, a Z-axis direction (first direction) is the stacking direction and a direction in which internal electrode layers face each other. An X-axis direction (second direction) is a longitudinal direction of the element body 10 and a direction in which the two end faces of the element body 10 are opposite to each other and in which the external electrode 20a is opposite to the external electrode 20b. AY-axis direction (third direction) is a width direction of the internal electrode layers and a direction in which the two side faces of the element body 10 are opposite to each other. The X-axis direction, the Y-axis direction and the Z-axis direction are orthogonal to each other.

The element body 10 has a structure designed to have dielectric layers 11 containing a ceramic material and internal electrode layers 12 alternately stacked. End edges of the internal electrode layers 12 are alternately exposed to a end face of the element body 10 on which the external electrode 20a is provided and a second end face of the element body 10 on which the external electrode 20b is provided. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. As long as the internal electrode layers 12 are exposed on two different surfaces and are electrically connected to different external electrodes, the configurations are not limited to those shown in FIG. 1 to FIG. 3.

For example, the multilayer ceramic capacitor 100 may have a length of 0.25 mm, a width of 0.125 mm and a height of 0.125 mm, or a length of 0.4 mm, a width of 0.2 mm and a height of 0.2 mm, or a length of 0.6 mm, a width of 0.3 mm and a height of 0.3 mm, or a length of 1.0 mm, a width of 0.5 mm and a height of 0.5 mmm or a length of 3.2 mm, a width of 1.6 mm and a height of 1.6 mm, or a length of 4.5 mm, a width of 3.2 mm and a height of 2.5 mm. However, the size of the multilayer ceramic capacitor 100 is not limited to the above sizes.

The main component of the internal electrode layer 12 is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material. The average thickness of each of the internal electrode layers 12 in the Z-axis direction is, for example, 1.5 μm or less, 1.0 μm or less, or 0.7 μm or less. The thickness of the internal electrode layers 12 can be measured by observing a cross section of the multilayer ceramic capacitor 100 with a SEM (scanning electron microscope), measuring the thickness at 10 points for each of 10 different internal electrode layers 12, and deriving the average value of all the measurement points.

A main component of the dielectric layer 11 is, for example, a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more. The thickness of the dielectric layers 11 is, for example, 5.0 μm or less, 3.0 μm or less, or 1.0 μm or less. The thickness of the dielectric layers 11 can be measured by observing a cross section of the multilayer ceramic capacitor 100 with a SEM (scanning electron microscope), measuring the thickness at 10 points for each of 10 different dielectric layers 11, and deriving the average value of all the measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where electrical capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no electrical capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

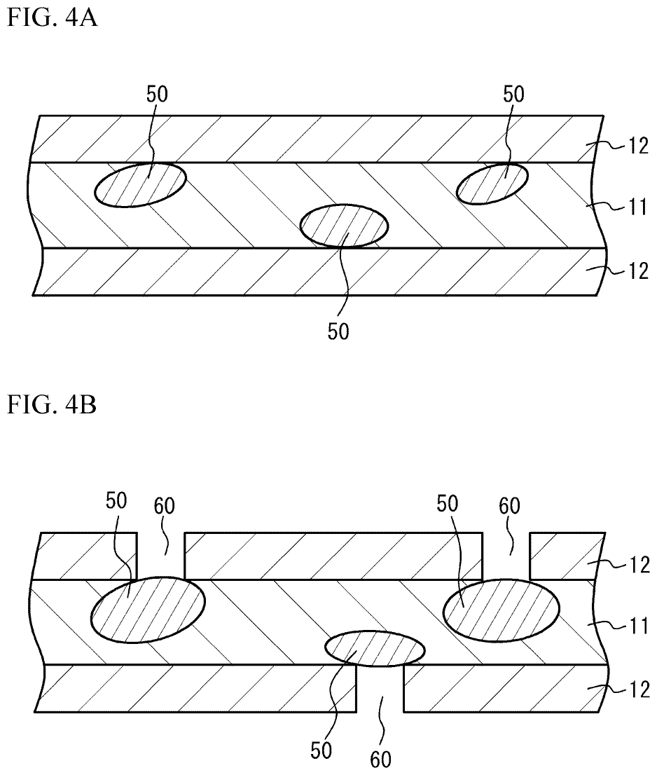

FIG. 4(a) is an enlarged view of the XZ cross section. As illustrated in FIG. 4(a), at least one of the dielectric layers 11 has a pyrochlore phase 50 in addition to the main phase. The dielectric layer 11 has the pyrochlore phase 50, which can suppress changes in the relative dielectric constant. This can realize excellent bias characteristics. Specifically, even when a high DC bias is applied, the decrease in the relative dielectric constant can be suppressed. In addition, excellent temperature characteristics can be realized. As an example, it becomes possible to realize temperature characteristics such as X7T, X8S, and X8R in the EIA standard. The reason why the pyrochlore phase 50 realizes excellent bias characteristics and excellent temperature characteristics is thought to be that, while a low dielectric constant phase is formed by the solid dissolution of a large amount of additive components, which greatly reduces the relative dielectric constant, the pyrochlore phase 50 of the formed R₂Ti₂O₇ has not only paraelectricity but also ferroelectricity.

The pyrochlore phase 50 contains a rare earth element and can be represented by the chemical formula R₂Ti₂O₇, where R is the rare earth element. In the pyrochlore phase 50, the rare earth element is not particularly limited, but is at least one of europium, samarium, gadolinium, terbium, dysprosium, holmium, erbium, or yttrium, for example. As an example, when the rare earth element is holmium, the pyrochlore phase 50 is Ho₂Ti₂O₇.

As illustrated in FIG. 4(b), the internal electrode layer 12 may have a partially broken discontinuous portion 60 formed therein. In such a case, it is preferable that the pyrochlore phase 50 covers the discontinuous portion 60 and contacts the internal electrode layer 12. In this configuration, the pyrochlore phase 50 contacts the discontinuous portion 60, so that the change in the relative dielectric constant can be appropriately suppressed without reducing reliability, and thus high bias characteristics and excellent temperature characteristics can be realized.

If the amount of the pyrochlore phase 50 is small, there is a risk that the change in the relative dielectric constant of the dielectric layer 11 is not sufficiently suppressed. Therefore, it is preferable to set a lower limit on the amount of the pyrochlore phase 50. In this embodiment, in the dielectric layer 11 having the pyrochlore phase 50, the cross-sectional area of the pyrochlore phase 50 in a cross section including the stacking direction for example, an XZ cross section) is preferably 5% or more, more preferably 10% or more, and even more preferably 15% or more.

On the other hand, if the amount of the pyrochlore phase 50 is too large, it may cause a decrease in the relative dielectric constant and a decrease in reliability. Therefore, it is preferable to set an upper limit on the amount of the pyrochlore phase 50. In this embodiment, in the dielectric layer 11 having the pyrochlore phase 50, the cross-sectional area of the pyrochlore phase 50 in a cross section including the stacking direction (for example, an XZ cross section) is preferably 20% or less, more preferably 15% or less, and even more preferably 10% or less. For example, the area ratio of the pyrochlore phase 50 can be measured by measuring the ratio of the cross-sectional area of the pyrochlore phase 50 when the entire cross-sectional area of the dielectric layer 11 is taken as 100%, such as in an SEM photograph.

If the dimensions of the pyrochlore phase 50 are small, there is a risk that the change in the relative dielectric constant of the dielectric layer 11 is not sufficiently suppressed. Therefore, it is preferable to set a lower limit on the dimensions of the pyrochlore phase 50. In this embodiment, the height of the pyrochlore phase 50 in the Z direction is preferably 10% or more of the average thickness of the dielectric layers 11, more preferably 25% or more, and even more preferably 30% or more. In addition, in the direction in which the internal electrode layer 12 extends (X-axis direction), the length of the pyrochlore phase is preferably 0.5 μm or more, more preferably 3 μm or more, and even more preferably 5.5 μm or more. The height of the pyrochlore phase 50 in the Z direction can be measured as the maximum length in the stacking direction of the dielectric layer 11. The length of the pyrochlore phase 50 can be measured as the maximum length in the direction in which the internal electrode layer 12 extends. Furthermore, the average value of the measured lengths is defined as the length.

On the other hand, if the dimensions of the pyrochlore phases 50 are large, this may lead to a significant decrease in the relative dielectric constant of the dielectric layer 11 and a decrease in reliability, so it is preferable to set an upper limit on the dimensions of the pyrochlore phases 50. In this embodiment, the height of the pyrochlore phases 50 in the Z direction is preferably 50% or less of the average thickness of the dielectric layers 11, more preferably 45% or less, and even more preferably 35% or less. In addition, in the direction in which the internal electrode layer 12 extends (X-axis direction), the length of the pyrochlore phases is preferably 9.0 μm or less, more preferably 7.5 μm or less, and even more preferably 6.0 μm or less.

In addition, it is preferable that the dielectric layer 11 contains sub-components so that the pyrochlore phase 50 is easily generated. Specifically, it is preferable that the dielectric layer 11 having the pyrochlore phase 50 contains a first sub-component containing at least one of silicon or lithium, a second sub-component containing boron, a third sub-component containing calcium, a fourth sub-component containing at least one of manganese or magnesium, and a fifth sub-component containing at least one of niobium, tungsten, or molybdenum. In addition, in the dielectric layer 11, the total amount of the first sub-component, the second sub-component, the third sub-component, the fourth sub-component, the fifth sub-component, and the rare earth element is preferably 20 mol or more, more preferably 23 mol or more, and even more preferably 29 mol or more, per 100 mol of titanium. Increasing the amount of the sub-components in this way makes it easier for the sub-components to form the pyrochlore phase 50 without being able to form a solid dissolution by substitution with the main component of the dielectric layer 11. In addition, increasing the amount of the sub-components reduces the sintering temperature of the dielectric layer 11, so that the element body 10 can be sintered at a low temperature. If the dielectric layer 11 contains silicon, an amorphous silicon liquid phase will be present during the sintering process, and the pyrochlore phase 50 will be stably formed in the discontinuous portion 60 of the internal electrode layer 12.

On the other hand, if the amount of the above-mentioned sub-components is large, there is a risk that the bias characteristics will deteriorate or the reliability will decrease. Therefore, it is preferable to set an upper limit on the amount of the above-mentioned sub-components. In this embodiment, in the dielectric layer 11, the total amount of the first sub-component, the second sub-component, the third sub-component, the fourth sub-component, the fifth sub-component, and the rare earth element is preferably 30 mol or less, more preferably 25 mol or less, and even more preferably 20 mol or less, per 100 mol of titanium.

For example, in the dielectric layer 11, when barium titanate is used as the ceramic having a perovskite structure, the fourth sub-component contains manganese, and the fifth sub-component contains molybdenum, the main component of the dielectric layer 11 may be barium titanate in which molybdenum and manganese are solid-dissolved.

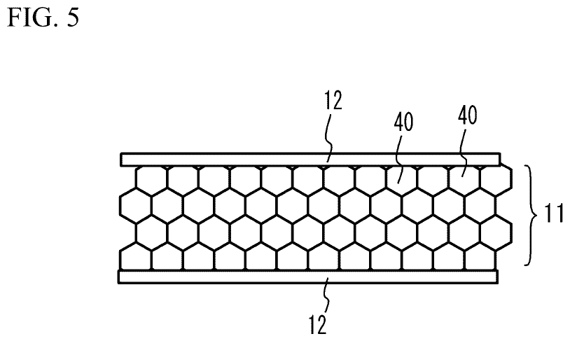

FIG. 5 is a cross-sectional view of a schematic representation of dielectric grains in the dielectric layer 11. As illustrated in FIG. 5, each of the dielectric layers 11 has a configuration in which a plurality of dielectric grains 40 are sintered. In order for the multilayer ceramic capacitor 100 to satisfy the X8S characteristic and the X8R characteristic, it is preferable to set a lower limit and an upper limit to the average grain size of the dielectric grains 40. In this embodiment, it is preferable that the average grain size of the dielectric grains 40 is 90 nm or more and 200 nm or less.

The average grain size of the dielectric grains 40 can be measured as follows. Specifically, the multilayer ceramic capacitor 100 is cut parallel to the end face on which the external electrodes are formed, and the cross section is polished. The cross section corresponds to a YZ cross section. The grain size of the dielectric grains is measured based on a cross-sectional photograph of the dielectric layer taken with a scanning electron microscope (SEM) of the cross section. The maximum length of the dielectric grains in the stacking direction based on the SEM image is taken as the grain size, and the arithmetic mean value of the measured grain sizes is taken as the average diameter of the dielectric grains. The polishing position here is set to be near the center, within a central region divided into five equal parts in the X-axis direction from the end faces of both external electrodes.

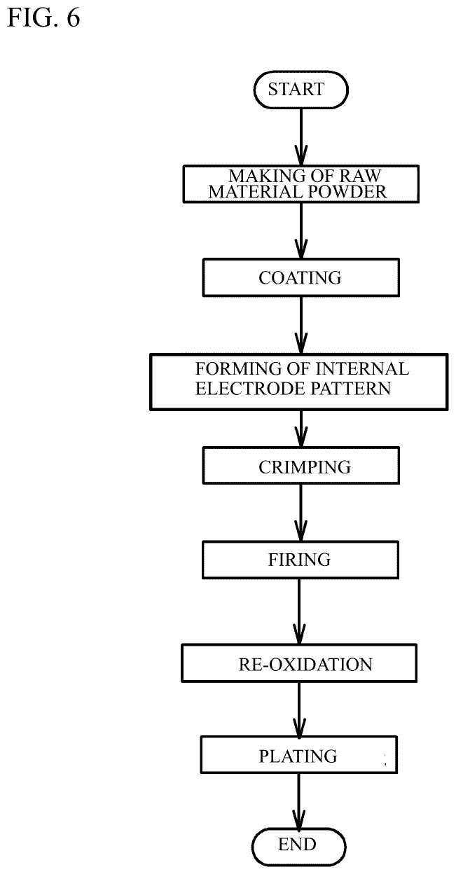

Next, a description will be given of a manufacturing method of the multilayer ceramic capacitors 100. FIG. 6 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate.

A predetermined additive compound is added to the obtained dielectric powder according to the purpose. As additives to the dielectric layer 11, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

In this embodiment, the sub-components that will form the pyrochlore phase 50 in the dielectric layer 11 after firing are added to the ceramic raw material powder. Specifically, the above-mentioned first sub-component, the second sub-component, the third sub-component, the fourth sub-component, the fifth sub-component, and the rare earth element are added. The total amount of the first sub-component, the second sub-component, the third sub-component, the fourth sub-component, the fifth sub-component, and the rare earth element is 20 mol or more per 100 mol of titanium.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

Next, a dielectric pattern material for forming the side margin 16 is prepared. The dielectric pattern material contains powder of the main component ceramic of the side margin 16. As the powder of the main component ceramic, for example, powder of the main component ceramic of the dielectric material can be used. Prescribed additive compounds are added depending on the purpose.

(Coating process) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The coating process is not illustrated.

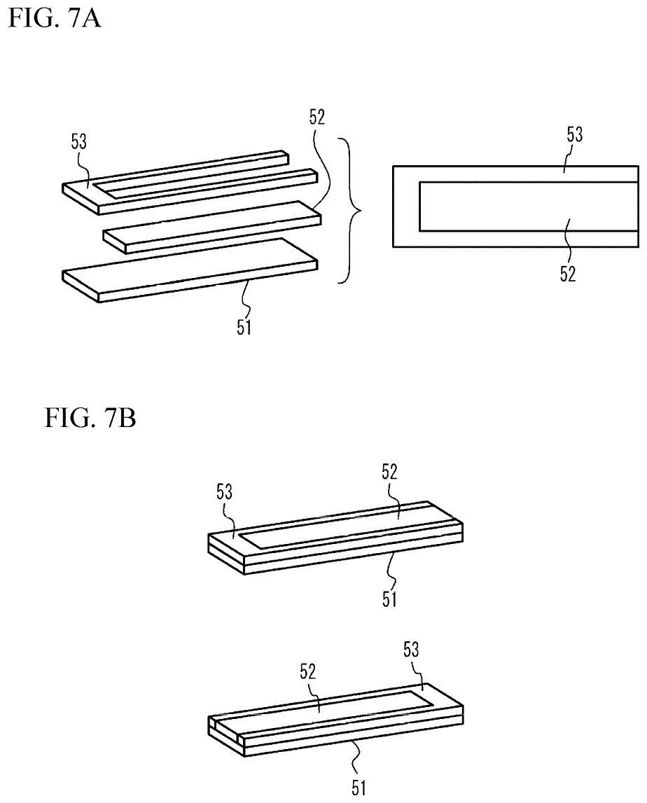

(Forming process of internal electrode pattern) Next, as illustrated in FIG. 7(a), a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 7(a), a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 7(b), a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 100 is 500 or more.

(Crimping process) A predetermined number (for example, 2 to 10) cover sheets 54 are stacked on the stacked stack units and under the stacked stack units, and the stacked structure is thermally crimped.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. A firing is performed for 5 minutes to 10 hours in a reducing atmosphere with an oxygen partial pressure of 10⁻⁵ to 10⁻⁸ atm in a temperature of 950° C. to 1200° C.

(Re-oxidation process) In order to return oxygen to the partially reduced main phase barium titanate of the dielectric layer 11 fired in a reducing atmosphere, N₂ and water vapor are mixed at about 1000° C. to an extent that the internal electrode layer 12 is not oxidized, heat treatment may be performed in gas or in the atmosphere at 500° C. to 700° C. This process is called a re-oxidation process.

(Plating process) After that, metal layers such as copper, nickel, and tin may be formed on the external electrodes 20a and 20b by plating. Thus, the multilayer ceramic capacitor 100 is manufactured.

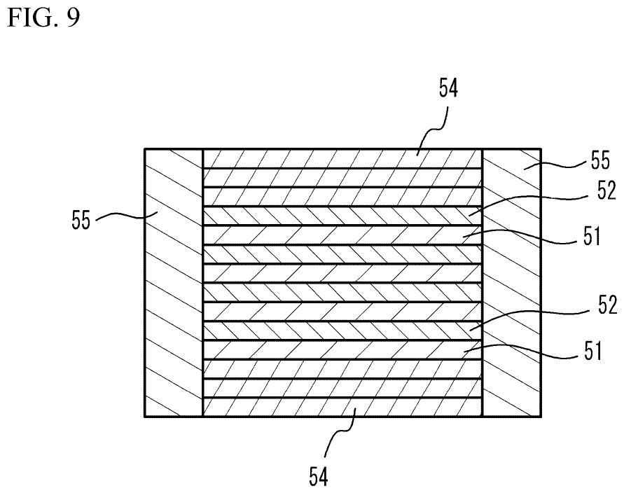

The side margins may be attached or applied to the side surfaces of the multilayer portion. Specifically, as illustrated in FIG. 9, the multilayer portion is obtained by alternately stacking the ceramic green sheets 51 and the internal electrode patterns 52 of the same width as the ceramic green sheets 51. Next, a sheet formed from the dielectric pattern paste may be attached as a side margin portion 55 to the side surfaces of the multilayer portion.

In the manufacturing method according to this embodiment, since the amount of the sub-components added to the titanium in the ceramic green sheet is large, these sub-components are not solid-dissolve in barium titanate, and the pyrochlore phase 50 is generated in the dielectric layer 11. Furthermore, since the amount of the sub-components added to the titanium is large, the sintering temperature is lowered. This allows low-temperature firing. For example, low-temperature firing at 950° C. to 1200° C. is possible.

In the above manufacturing method, the pyrochlore phase 50 is generated during the firing process, but this is not limited to this. For example, particles of the pyrochlore phase may be added to the dielectric material. In this way, the pyrochlore phase 50 can be contained in the dielectric layer 11.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Examples

(Examples 1-5 and Comparative Examples 1 and 2) A dielectric raw material powder was prepared by adding sub-components to a powder of barium titanate (MoMnBT) in which molybdenum and manganese are solid-dissolved, as the main component. The amount of holmium was 3.0 mol in Examples 1-3, 3.5 mol in Example 5, and 2.0 mol in Comparative Examples 1 and 2, relative to 100 mol of titanium. In Example 4, the amount of holmium was 0 mol, and the amount of dysprosium was 3.0 mol. The amount of silicon was 8.0 mol in Examples 1 and 2, 6.0 mol in Example 3, 8.0 mol in Example 4, 9.5 mol in Example 5, 1.5 mol in Comparative Example 1, and 5.0 mol in Comparative Example 2, relative to 100 mol of titanium. Manganese was 4.0 mol in Example 1, 5.0 mol in Example 2, 3.5 mol in Example 3, 4.0 mol in Example 4, 5.0 mol in Example 5, 1.0 mol in Comparative Example 1, and 5.0 mol in Comparative Example 2, relative to 100 mol of titanium. Calcium was 10.0 mol in Example 1, 4.0 mol in Example 2, 2.5 mol in Example 3, 10.0 mol in Example 4, 7.0 mol in Example 5, 0.5 mol in Comparative Example 1, and 3.0 mol in Comparative Example 2, relative to 100 mol of titanium. Boron was 5.0 mol in Examples 1 to 4, 5.5 mol in Example 5, 0.0 mol in Comparative Example 1, and 4.0 mol in Comparative Example 2, relative to 100 mol of titanium. Each condition is shown in Table 1.

TABLE 1

| | | | | | | | | TOTAL |
|---|---|---|---|---|---|---|---|---|
| | | Ho | Dy | Si | Mn | Ca | B | AMOUNT |
| | MATERIAL | (mol %) | (mol %) | (mol %) | (mol %) | (mol %) | (mol %) | (mol %) |
| EXAMPLE 1 | MoMnBT | 3.0 | 0.0 | 8.0 | 4.0 | 10.0 | 5.0 | 30.0 |
| EXAMPLE 2 | MoMnBT | 3.0 | 0.0 | 8.0 | 5.0 | 4.0 | 5.0 | 25.0 |
| EXAMPLE 3 | MoMnBT | 3.0 | 0.0 | 6.0 | 3.5 | 2.5 | 5.0 | 20.0 |
| EXAMPLE 4 | MoMnBT | 0.0 | 3.0 | 8.0 | 4.0 | 10.0 | 5.0 | 30.0 |
| EXAMPLE 5 | MoMnBT | 3.5 | 0.0 | 9.5 | 5.0 | 7.0 | 5.5 | 31.0 |
| COMPARATIVE | MoMnBt | 2.0 | 0.0 | 1.5 | 1.0 | 0.5 | 0.0 | 5.0 |
| EXAMPLE 1 | | | | | | | | |
| COMPARATIVE | MoMnBT | 2.0 | 0.0 | 5.0 | 5.0 | 3.0 | 4.0 | 19.0 |
| EXAMPLE 2 | | | | | | | | |

Then, the dielectric raw material powder was wet mixed with an organic solvent. The binder was added to the slurry, which was then coated on a ceramic green sheet by the doctor blade method and dried. A Ni-containing conductive paste film was screen-printed in a predetermined pattern on the ceramic green sheet to form an internal electrode pattern. In addition, in order to fill the step between the ceramic green sheet and the internal electrode pattern, a reverse pattern sheet having a pattern complementary to the internal electrode pattern was screen-printed on the ceramic green sheet. The ceramic green sheets were then stacked, pressed, and cut to obtain a compact.

The MLCC compact sample was de-bindered at a temperature of 300° C. in an N₂ atmosphere. It was then fired at a temperature range of 1300° C. to 1250° C. in a reducing atmosphere with an oxygen partial pressure of 10⁻⁵ atm to 10⁻⁸ atm. After cooling, it was heated to a temperature range of 800° C. to 1050° C. in an N₂ atmosphere, and the temperature was maintained to perform a re-oxidation treatment.

(Presence or absence of pyrochlore phase) The XZ cross section was observed with an SEM to confirm the presence or absence of pyrochlore phase in the dielectric layer. In Examples 1 to 5, the pyrochlore phase was confirmed in the dielectric layer. In all of Examples 1 to 5, it was confirmed that the pyrochlore phase was in contact with the adjacent internal electrode layer, covering the discontinuous parts of the internal electrode. On the other hand, the pyrochlore phase was not confirmed in Comparative Examples 1 and 2. This is thought to be due to the small amount of rare earth components added.

(Area ratio of pyrochlore phase) In the XZ cross section, the area ratio of the pyrochlore phase was measured when the cross-sectional area of the dielectric layer was taken as 100%. It was 20% in Example 1, 13% in Example 2, 7% in Example 3, 19% in Example 4, and 23% in Example 5.

(Height of pyrochlore phase) In the XZ cross section, the height ratio (%) of the pyrochlore phase was measured when the thickness of the dielectric layer was taken as 100%. It was 45.0% in Example 1, 20.0% in Example 2, 12.0% in Example 3, 40.0% in Example 4, and 54.0% in Example 5.

(Length of pyrochlore phase) In the XZ cross section, the length (m) of the pyrochlore phase in the X direction was measured. In Example 1, it was 8.5 μm, in Example 2, it was 6.5 μm, in Example 3, it was 0.7 μm, in Example 4, it was 8.8 μm and in Example 5, it was 9.1 μm.

(Bias characteristics) The bias characteristics were measured for the multilayer ceramic capacitors of Examples 1 to 5 and Comparative Examples 1 and 2. Specifically, the measurements were performed by applying a DC bias of 3 V. The measured relative dielectric constant was 500 in Example 1, 510 in Example 2, 540 in Example 3, 500 in Example 4, 480 in Example 5, 1000 in Comparative Example 1, and 620 in Comparative Example 2.

(Temperature characteristics) The temperature characteristics were examined for the multilayer ceramic capacitors of Examples 1 to 5 and Comparative Examples 1 and 2. Examples 1 and 4 satisfied the X8R characteristics. Examples 2, 3, and 5 satisfied the X8S characteristics. Comparative Example 1 did not satisfy the X7T characteristics. Comparative Example 2 satisfied the X7T standard.

(Overall judgement) For Examples 1 to 5 and Comparative Examples 1 and 2, if the bias characteristic was 500 or more and the X8R or X8S characteristic was satisfied, the overall judgement was judged to be good “o”. If the X8R or X8S characteristic was satisfied but the bias characteristic was 450 or more but less than 500, the overall judgement was judged to be somewhat good “A”. If the bias characteristic was 500 or more but neither the X8R nor the X8S characteristic was satisfied, the overall judgement was judged to be bad “x”. The results are shown in Table 2.

TABLE 2

| | PYROCHLORE PHASE | | | | | |
|---|---|---|---|---|---|---|
| | AREA | | | | | |
| | RATIO | HEIGHT | LENGTH | BIAS | TEMPERATURE | |
| | (%) | (%) | (μm) | CHARACTERISTICS | CHARACTERISTICS | JUDGE |
| EXAMPLE 1 | 20 | 45.0 | 8.5 | 500 | X8R | ∘ |
| EXAMPLE 2 | 13 | 20.0 | 6.5 | 510 | X8S | ∘ |
| EXAMPLE 3 | 7 | 12.0 | 0.7 | 540 | X8S | ∘ |
| EXAMPLE 4 | 19 | 40.0 | 8.8 | 500 | X8R | ∘ |
| EXAMPLE 5 | 23 | 54.0 | 9.1 | 480 | X8S | Δ |
| COMPARATIVE | — | — | — | 1000 | X5S | x |
| EXAMPLE 1 | | | | | | |
| COMPARATIVE | — | — | — | 620 | X7T | x |
| EXAMPLE 2 | | | | | | |

For Examples 1 to 5, the overall judgement was judged to be good “o” or somewhat good “A”. This is believed to be because the pyrochlore phase was formed in the dielectric layer. On the other hand, for Comparative Examples 1 and 2, the overall judgement was judged to be bad “x”. This is believed to be because the pyrochlore phase was not formed in the dielectric layer.

The reason why the results of Examples 1 to 4 were better than those of Example 5 is believed to be that the total amount of the sub-components was 30 mol or less per 100 mol of titanium, so that the pyrochlore phase exceeding 50% of the thickness of the dielectric layer was not generated, resulting in good bias characteristics and good reliability.

Although the embodiments of the present invention have been described in detail, it is to be understood that the various change, substitutions, and alterations could be made hereto without departing from the spirit and scope of the invention.

### BRIEF DESCRIPTION OF NUMERALS

10 element body
11 dielectric layer
12 internal electrode layer
13 cover layer
14 capacity section
15 end margin
16 side margin
20a, 20b external electrode
51 ceramic green sheet
52 internal electrode pattern
53 dielectric pattern
54 cover sheet
55 side margin portion
100 multilayer ceramic capacitor

1. A multilayer ceramic electronic device comprising:
an element body including a multilayer portion in which a plurality of dielectric layers and a plurality of internal electrode layers are stacked,
wherein at least one of the plurality of dielectric layers includes a pyrochlore phase.

2. The multilayer ceramic electronic device as claimed in claim 1, wherein the pyrochlore phase is in contact with an adjacent one of the plurality of internal electrode layers.

3. The multilayer ceramic electronic device as claimed in claim 2,
wherein the adjacent one of the plurality of internal electrode layers includes a discontinuous portion, and
wherein the pyrochlore phase covers the discontinuous portion and is in contact with the adjacent one of the plurality of internal electrode layers.

4. The multilayer ceramic electronic device as claimed in claim 1,
wherein, in the at least one of the plurality of dielectric layers including the pyrochlore phase, a cross section area of the pyrochlore phase in a cross section including a stacking direction is 5% or more and 20% or less.

5. The multilayer ceramic electronic device as claimed in claim 1, wherein, in the at least one of the plurality of dielectric layers including the pyrochlore phase, a cross section area of the pyrochlore phase in a cross section including a stacking direction is 10% or more and 20% or less.

6. The multilayer ceramic electronic device as claimed in claim 1, wherein a height of the pyrochlore phase in a stacking direction is 10% or more and 50% or less of an average thickness of the plurality of dielectric layers.

7. The multilayer ceramic electronic device as claimed in claim 1, wherein a length of the pyrochlore phase in a direction in which the plurality of internal electrode layers extend is 0.5 μm or more and 9.0 μm or less.

8. The multilayer ceramic electronic device as claimed in claim 1,
wherein a main component of the plurality of dielectric layers is barium titanate,
wherein the pyrochlore phase includes a rare earth element, and
wherein the pyrochlore phase is represented by a chemical formula R₂Ti₂O₇, where R is the rare earth element.

9. The multilayer ceramic electronic device as claimed in claim 8,
wherein the rare earth element is at least one of europium, samarium, gadolinium, terbium,
dysprosium, holmium, erbium, or yttrium.

10. The multilayer ceramic electronic device as claimed in claim 8,
wherein the rare earth element is holmium.

11. The multilayer ceramic electronic device as claimed in claim 1,
wherein the plurality of dielectric layers include a first sub-component including at least one of silicon or lithium, a second sub-component including boron, a third sub-component including calcium, a fourth sub-component including at least one of manganese or magnesium, and a fifth sub-component including at least one of niobium, tungsten, or molybdenum, and
wherein a total amount of the first sub-component, the second sub-component, the third sub-component, the fourth sub-component, the fifth sub-component, and the rare earth element in the plurality of dielectric layers is 20 mol or more and 30 mol or less per 100 mol of titanium.

12. The multilayer ceramic electronic device as claimed in claim 1, wherein a main component of the plurality of dielectric layers is barium titanate in which molybdenum and manganese are solid-dissolved.

13. The multilayer ceramic electronic device as claimed in claim 1,
wherein the multilayer ceramic electronic device satisfies X8S characteristics or X8R characteristics in EIA standard.
